(19) United States
(12) Patent Application Publication
(10) Pub. No.: US 2016/0077357 A1
(43) Pub. Date: Mar. 17, 2016

(54) Height Adjustment System for Eyeglasses

(71) Applicants: Alice Marie Miller, Roswell, NM (US); Frank Wayne Nason, Roswell, NM (US)

(72) Inventors: Alice Marie Miller, Roswell, NM (US); Frank Wayne Nason, Roswell, NM (US)

(21) Appl. No.: 14/746,584

(22) Filed: Jun. 22, 2015

Related U.S. Application Data
(60) Provisional application No. 62/051,752, filed on Sep. 17, 2014.

(51) Int. Cl. G02C 5/14

(52) U.S. Cl. CPC G02C 5/143

(57) ABSTRACT

A height adjustment system for eyeglasses is used to properly align a pair of glasses on uneven ears. The system includes a first temple arm which is used to support an eyeglasses frame on a user's head. A height adjuster is connected to a first bottom surface of the first temple arm and is used to compensate for the height difference between the user's ears. The height adjuster is positioned next to a free end of the first temple arm such that the height adjuster aligns with the user's ear. A first ear rest is connected to the height adjuster and is used to prevent the first temple arm from falling off of the user's head. Further, the system includes a second temple arm and an eyeglasses frame. The first temple arm and the second temple arm are connected to opposite ends of the eyeglasses frame.

The current application claims a priority to the U.S. Provisional Patent application Ser. No. 62/051,752 filed on Sep. 17, 2014.

### FIELD OF THE INVENTION

The present invention relates generally to eyeglasses. More specifically, the present invention relates to a new and useful height adjustment system for eyeglasses which is used to properly align a pair of glasses on uneven ears. For users with uneven ears, the present invention is used to compensate for the height difference between ears such that the frame of a pair of glasses sits properly on the user's face.

### BACKGROUND OF THE INVENTION

Eyeglasses are commonly used to help people see and mainly consist of lenses, a frame, and two temple arms. The temple arms are usually hingedly connected to the frames and extend to fit over the user's ears. Currently, temple arms are only designed to properly fit on a user with perfectly even ears. Any slight differences in the heights of a user's ears can cause the glasses sit crookedly on the user's face.

To fix this problem, the user can go to an optometrist and have the temple arms bent slightly until a proper fit is achieved. However, in the event that the temple arms are bent further during normal use or incidental damage, the user will have to return to the optometrist to have the temple arms bent back to the correct position. Generally, it is not advised that the user tries to bend the temple arms without professional assistance because the temple arms may easily be damaged or broken.

Accordingly, there is a present need for an improved temple arm invention that does not need to be bent to accommodate ears of different heights. The present invention is a new and useful height adjustment system for eyeglasses which is used to compensate for an otherwise uneven fit. If a user's ears are not perfectly aligned, the present invention can be used to lift one temple arm to the point where the eyeglasses frame is properly aligned on the user's face.

### BRIEF DESCRIPTION OF THE DRAWINGS

FIG. 1 is a top perspective view of the present invention.

FIG. 2 is a bottom perspective view of the present invention.

FIG. 3 is a top perspective view of the present invention, wherein the ear rest is connected to the height adjuster.

FIG. 4 is a bottom perspective view of the present invention, wherein the ear rest is connected to the height adjuster.

FIG. 5 is a front view of the present invention, wherein the ear rest is connected to the height adjuster.

FIG. 6 is a detailed front view taken about the circle A in FIG. 5.

FIG. 7 is a top perspective view of an embodiment of the present invention, wherein the embodiment is configured such that first temple arm and the second temple arm are connected to the eyeglasses frame.

FIG. 8 is a bottom perspective view of the embodiment of the present invention, wherein the embodiment is configured such that the first temple arm and the second temple arm are connected to the eyeglasses frame.

FIG. 9 is a top perspective view of an alternative embodiment of the present invention, wherein the second temple arm of the alternative embodiment does not have an ear rest.

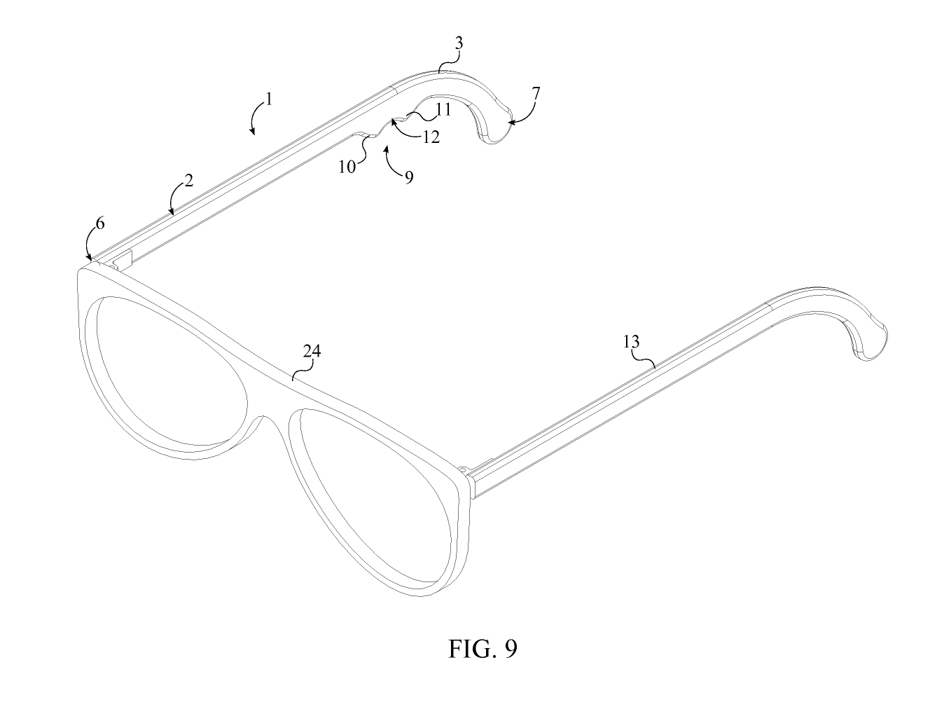

### DETAILED DESCRIPTION OF THE INVENTION

All illustrations of the drawings are for the purpose of describing selected versions of the present invention and are not intended to limit the scope of the present invention.

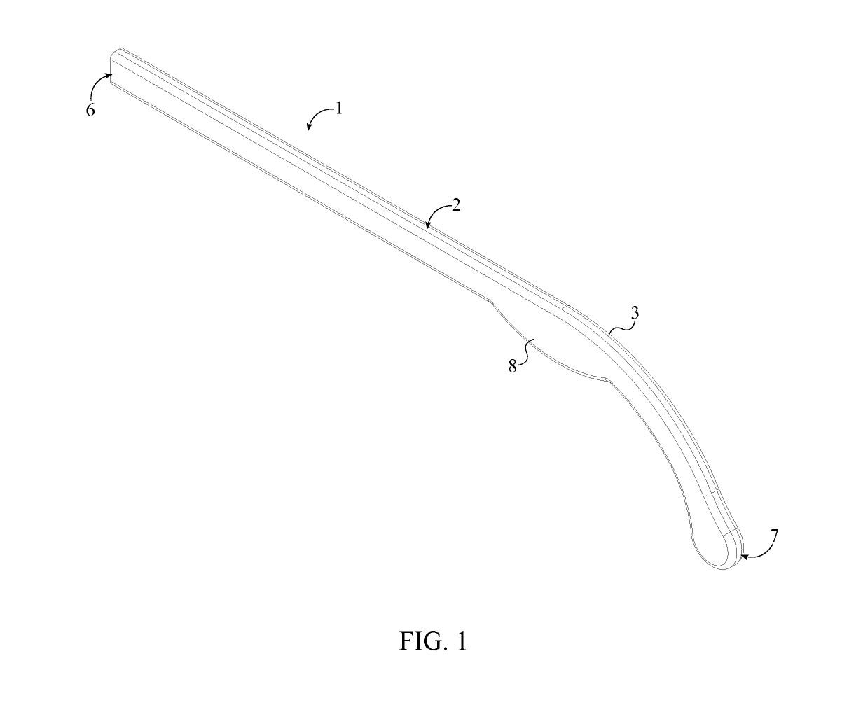

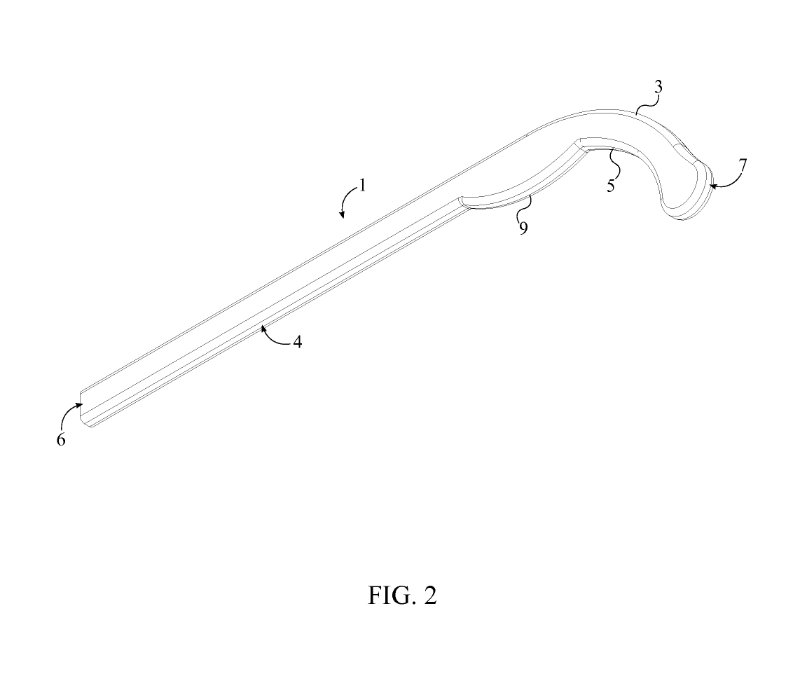

With reference to FIGS. 1-2, the present invention is a height adjustment system for eyeglasses that is used to properly fit a pair of glasses to the head of a user. For people with uneven ears, the present invention may be used to compensate for the height difference between ears. When worn, the present invention makes it possible for a pair of glasses fit correctly on a user's face. The present invention comprises a first temple arm 1 and a height adjuster 8. The first temple arm 1 is used to support a pair of glasses on a user's face. The first temple arm 1 comprises a first top surface 2, a first bottom surface 4, a first hinged end 6, and a first free end 7. The first top surface 2 and the first bottom surface 4 are positioned opposite to each other about the first temple arm 1. The first hinged end 6 and the first free end 7 are positioned opposite to each other along the first temple arm 1. The first hinged end 6 may be connected to the frame of a pair of glasses, and the first free end 7 extends towards the back of the user's head when worn. A first convex portion 3 of the first top surface 2 is positioned opposite to a first concave portion 5 of the first bottom surface 4 about the first temple arm 1. The first convex portion 3 and the first concave portion 5 are designed to be positioned just past the user's ear such that when the present invention is worn, the first temple arm 1 fits around the user's ear. This helps to prevent the first temple arm 1 from slipping off of the user's head when the present invention is worn by the user.

The height adjuster 8 is used to compensate for any difference in height between the user's ears. The height adjuster 8 is laterally connected along the first bottom surface 4 and is positioned adjacent to the first free end 7. Because users may have ears which are uneven to different extents, the height adjuster 8 may be custom fit for each user, or the height adjuster 8 may be produced in a number of varying standard sizes. To adjust for the user's uneven ears, the first temple arm 1 must be secured over whichever ear sits lower on the user's head. The height adjuster 8 is positioned between the first temple arm 1 and the user's ear such that the first temple arm 1 is raised to the point of being even with the temple arm on the other side of the user's head.

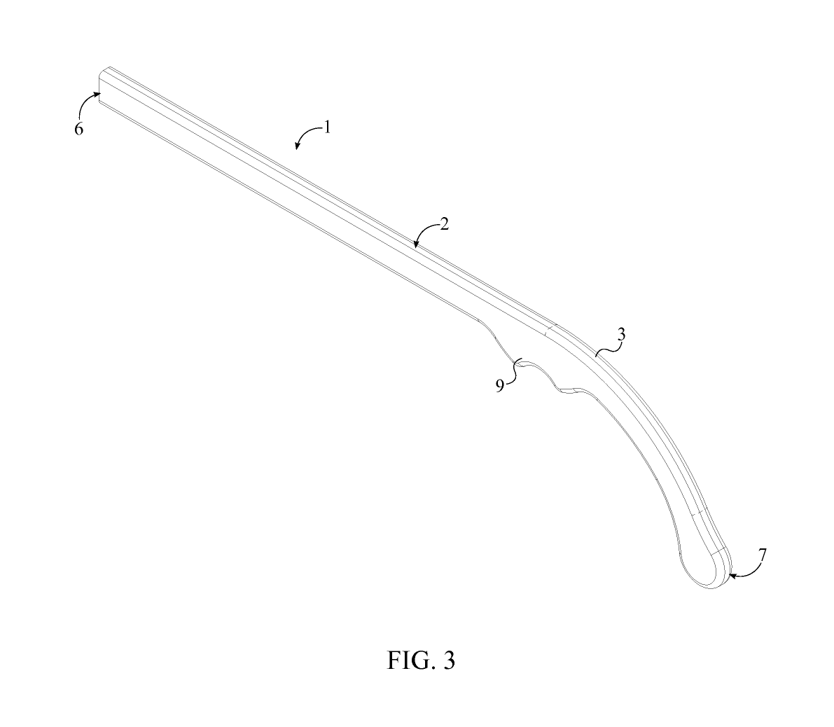

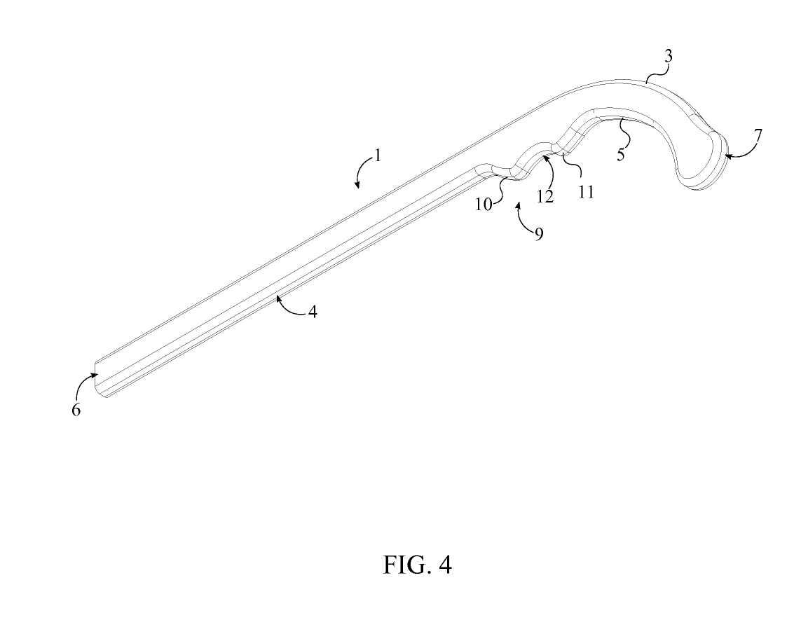

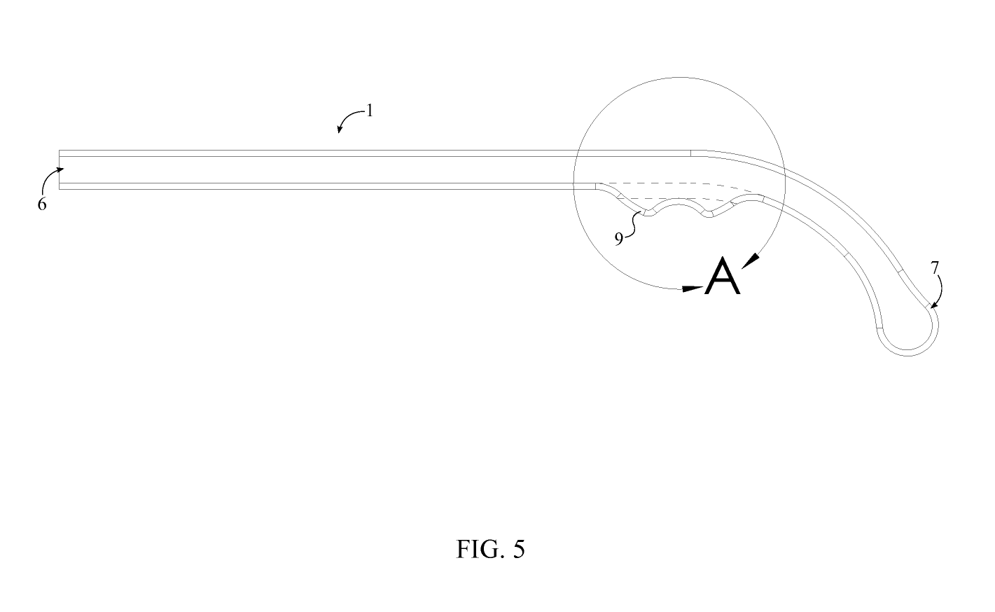

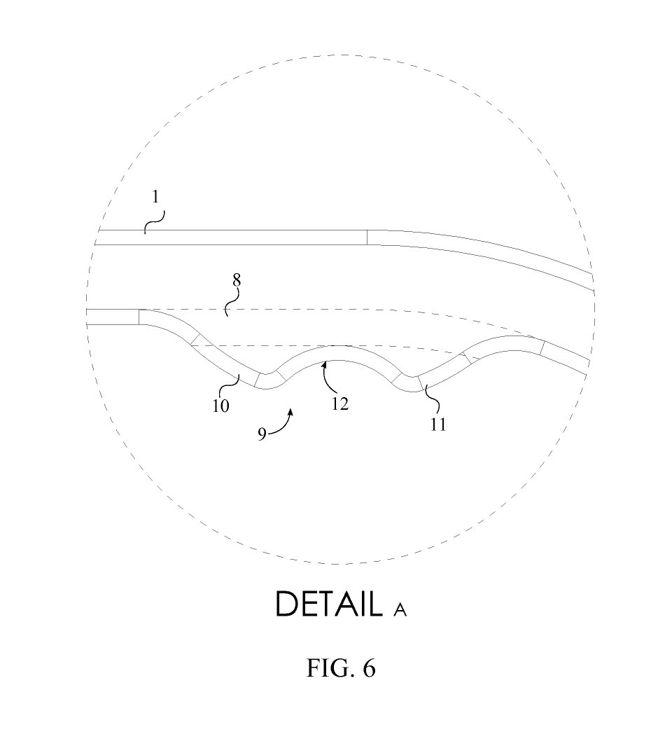

In reference to FIGS. 3-4, the present invention further comprises a first ear rest 9. The first ear rest 9 is used to provide a secure fit for the first temple arm 1 on the user's head. The first ear rest 9 helps to prevent a pair of glasses from falling off a user's head and is attached adjacent to the height adjuster 8, opposite the first temple arm 1. This is shown in FIGS. 5-6. The first ear rest 9 comprises a first front protrusion 10, a first back protrusion 11, and a first rest surface 12. The first front protrusion 10 and the first back protrusion 11 are used to prevent a pair of glasses from falling off of a user's head. The first front protrusion 10 is positioned in between the first hinged end 6 and the first free end 7 and prevents a pair of glasses from shifting towards the back of a user's head. The first back protrusion 11 is positioned in between the first front protrusion 10 and the first free end 7 and prevents a pair of glasses from shifting towards the front of a user's head. The first rest surface 12 is positioned in between the first front protrusion 10 and the first back protrusion 11. The first rest surface 12 is used to provide a valley which comfortably sits over the user's ear.

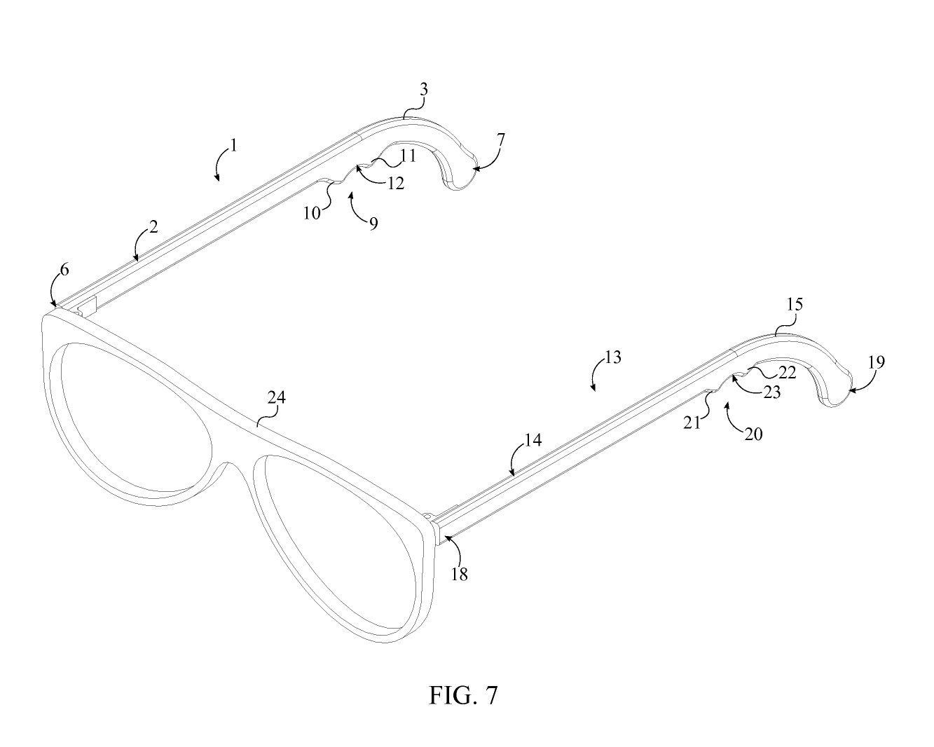

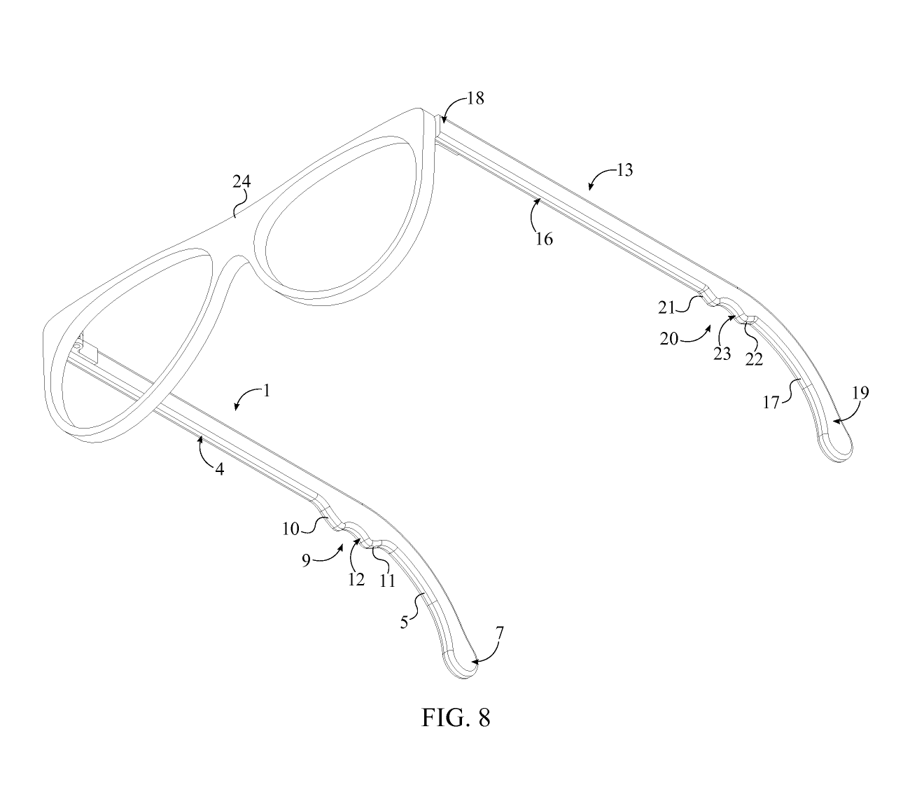

In reference to FIGS. 7-8, the present invention further comprises a second temple arm 13, a second ear rest 20, and an eyeglasses frame 24 Like a normal pair of glasses, the eyeglasses frame 24 is used to hold lenses which help the user to see more clearly. The first temple arm 1 is hingedly connected to the eyeglasses frame 24. The second temple arm 13 is hingedly connected to the eyeglasses frame 24, opposite to the first temple arm 1. The first temple arm 1 and the second temple arm 13 are able to fold outwards when the user wishes to wear the pair of glasses, or fold inwards to make the glasses more compact. The second ear rest 20 is laterally connected to the second temple arm 13 and, like the first ear rest 9, is used to help secure the pair of glasses to the user's head. Together, the first ear rest 9 and the second ear rest 20 provide a comfortable fit for the glasses and prevent the glasses from falling off of the user's face.

Similar to the first temple arm 1, the second temple arm 13 comprises a second top surface 14, a second bottom surface 16, a second hinged end 18, and a second free end 19. The second top surface 14 and the second bottom surface 16 are positioned opposite to each other about the second temple arm 13. The second hinged end 18 and the second free end 19 are positioned opposite to each other along the second temple arm 13. The second temple arm 13 is hingedly connected to the eyeglasses frame 24 about the second hinged end 18. A second convex portion 15 of the second top surface 14 is positioned opposite to a second concave portion 17 of the second bottom surface 16 about the second temple arm 13. The second convex portion 15 and the second concave portion 17 are designed to be positioned just past the user's ear such that when the present invention is worn, the second temple arm 13 fits around the user's ear. This helps to prevent the second temple arm 13 from slipping off of the user's head when worn. The second ear rest 20 is laterally connected along the second bottom surface 16 such that when the user is wearing their glasses, the second ear rest 20 is positioned between the user's ear and the second temple arm 13. The second ear rest 20 is positioned adjacent to the second free end 19 such that the ear rest aligns with the user's ear when worn.

The second ear rest 20 comprises a second front protrusion 21, a second back protrusion 22, and a second rest surface 23. The second front protrusion 21 and the second back protrusion 22 are used to prevent a pair of glasses from falling off of a user's head. The second front protrusion 21 is positioned in between the second hinged end 18 and the second free end 19 and prevents a pair of glasses from shifting towards the back of a user's head. The second back protrusion 22 is positioned in between the second front protrusion 21 and the second free end 19 and prevents a pair of glasses from shifting towards the front of a user's head. The second rest surface 23 is positioned in between the second front protrusion 21 and the second back protrusion 22. The second rest surface 23 is used to comfortably sit upon a user's ear.

In an alternative embodiment of the present invention, the second ear rest 20 is not connected to the second temple arm 13. Instead, the second temple arm 13 more closely resembles a normal temple arm. For this embodiment, the eyeglasses frame 24 and the second temple arm 13 may be parts of a pair of glasses that the user already owns. The first temple arm 1 may act as a replacement for an initial temple arm that was previously part of the eyeglasses. With this system, the user may replace the initial temple arm with the first temple arm 1 such that the eyeglasses are properly aligned.

Although the invention has been explained in relation to its preferred embodiment, it is to be understood that many other possible modifications and variations can be made without departing from the spirit and scope of the invention as hereinafter claimed.

What is claimed is:

1. A height adjustment system for eyeglasses comprises:
a first temple arm;
a height adjuster;
the first temple arm comprises a first top surface, a first bottom surface, a first hinged end, and a first free end;
the first top surface and the first bottom surface being positioned opposite to each other about the first temple arm;
the first hinged end and the first free end being positioned opposite to each other along the first temple arm;
a first convex portion of the first top surface being positioned opposite to a first concave portion of the first bottom surface about the first temple arm;
the height adjuster being laterally connected along the first bottom surface; and
the height adjuster being positioned adjacent to the first free end.

2. The height adjustment system for eyeglasses as claimed in claim 1 comprises:
a first ear rest; and
the first ear rest being attached adjacent to the height adjuster, opposite the first temple arm.

3. The height adjustment system for eyeglasses as claimed in claim 2 comprises:
the first ear rest comprises a first front protrusion, a first back protrusion, and a first rest surface;
the first front protrusion being positioned in between the first hinged end and the first free end;
the first back protrusion being positioned in between the first front protrusion and the first free end; and
the first rest surface being positioned in between the first front protrusion and the first back protrusion.

4. The height adjustment system for eyeglasses as claimed in claim 1 comprises:
a second temple arm;
a second ear rest;
an eyeglasses frame;
the first temple arm being hingedly connected to the eyeglasses frame;
the second temple arm being hingedly connected to the eyeglasses frame, opposite to the first temple arm; and
the second ear rest being laterally connected to the second temple arm.

5. The height adjustment system for eyeglasses as claimed in claim 4 comprises:
the second temple arm comprises a second top surface, a second bottom surface, a second hinged end, and a second free end;
the second top surface and the second bottom surface being positioned opposite to each other about the second temple arm;
the second hinged end and the second free end being positioned opposite to each other along the second temple arm;
a second convex portion of the second top surface being positioned opposite to a second concave portion of the second bottom surface about the second temple arm;
the second ear rest being laterally connected along the second bottom surface; and
the second ear rest being positioned adjacent to the second free end.

6. The height adjustment system for eyeglasses as claimed in claim 4 comprises:
the second ear rest comprises a second front protrusion, a second back protrusion, and a second rest surface;
the second front protrusion being positioned in between the second hinged end and the second free end;
the second back protrusion being positioned in between the second front protrusion and the second free end; and
the second rest surface being positioned in between the second front protrusion and the second back protrusion.

7. A height adjustment system for eyeglasses comprises:
a first temple arm;
a height adjuster;
a first ear rest;
the first temple arm comprises a first top surface, a first bottom surface, a first hinged end, and a first free end;
the first top surface and the first bottom surface being positioned opposite to each other about the first temple arm;
the first hinged end and the first free end being positioned opposite to each other along the first temple arm;
a first convex portion of the first top surface being positioned opposite to a first concave portion of the first bottom surface about the first temple arm;
the height adjuster being laterally connected along the first bottom surface;
the height adjuster being positioned adjacent to the first free end; and
the first ear rest being attached adjacent to the height adjuster, opposite the first temple arm.

8. The height adjustment system for eyeglasses as claimed in claim 7 comprises:
the first ear rest comprises a first front protrusion, a first back protrusion, and a first rest surface;
the first front protrusion being positioned in between the first hinged end and the first free end;
the first back protrusion being positioned in between the first front protrusion and the first free end; and
the first rest surface being positioned in between the first front protrusion and the first back protrusion.

9. The height adjustment system for eyeglasses as claimed in claim 7 comprises:
a second temple arm;
a second ear rest;
an eyeglasses frame;
the first temple arm being hingedly connected to the eyeglasses frame;
the second temple arm being hingedly connected to the eyeglasses frame, opposite to the first temple arm; and
the second ear rest being laterally connected to the second temple arm.

10. The height adjustment system for eyeglasses as claimed in claim 9 comprises:
the second temple arm comprises a second top surface, a second bottom surface, a second hinged end, and a second free end;
the second top surface and the second bottom surface being positioned opposite to each other about the second temple arm;
the second hinged end and the second free end being positioned opposite to each other along the second temple arm;
a second convex portion of the second top surface being positioned opposite to a second concave portion of the second bottom surface about the second temple arm;
the second ear rest being laterally connected along the second bottom surface; and
the second ear rest being positioned adjacent to the second free end.

11. The height adjustment system for eyeglasses as claimed in claim 9 comprises:
the second ear rest comprises a second front protrusion, a second back protrusion, and a second rest surface;
the second front protrusion being positioned in between the second hinged end and the second free end;
the second back protrusion being positioned in between the second front protrusion and the second free end; and
the second rest surface being positioned in between the second front protrusion and the second back protrusion.

12. A height adjustment system for eyeglasses comprises:
a first temple arm;
a height adjuster;
a first ear rest;
a second temple arm;
a second ear rest;
an eyeglasses frame;
the first temple arm comprises a first top surface, a first bottom surface, a first hinged end, and a first free end;
the first top surface and the first bottom surface being positioned opposite to each other about the first temple arm;
the first hinged end and the first free end being positioned opposite to each other along the first temple arm;
a first convex portion of the first top surface being positioned opposite to a first concave portion of the first bottom surface about the first temple arm;
the height adjuster being laterally connected along the first bottom surface;
the height adjuster being positioned adjacent to the first free end;
the first ear rest being attached adjacent to the height adjuster, opposite the first temple arm;
the first temple arm being hingedly connected to the eyeglasses frame;
the second temple arm being hingedly connected to the eyeglasses frame, opposite to the first temple arm; and
the second ear rest being laterally connected to the second temple arm.

13. The height adjustment system for eyeglasses as claimed in claim 12 comprises:
the first ear rest comprises a first front protrusion, a first back protrusion, and a first rest surface;
the first front protrusion being positioned in between the first hinged end and the first free end;
the first back protrusion being positioned in between the first front protrusion and the first free end; and
the first rest surface being positioned in between the first front protrusion and the first back protrusion.

14. The height adjustment system for eyeglasses as claimed in claim 12 comprises:
the second temple arm comprises a second top surface, a second bottom surface, a second hinged end, and a second free end;
the second top surface and the second bottom surface being positioned opposite to each other about the second temple arm;
the second hinged end and the second free end being positioned opposite to each other along the second temple arm;
a second convex portion of the second top surface being positioned opposite to a second concave portion of the second bottom surface about the second temple arm;
the second ear rest being laterally connected along the second bottom surface; and
the second ear rest being positioned adjacent to the second free end.

15. The height adjustment system for eyeglasses as claimed in claim 12 comprises:
the second ear rest comprises a second front protrusion, a second back protrusion, and a second rest surface;
the second front protrusion being positioned in between the second hinged end and the second free end;
the second back protrusion being positioned in between the second front protrusion and the second free end; and
the second rest surface being positioned in between the second front protrusion and the second back protrusion.
